(19) United States
(12) Patent Application Publication
(10) Pub. No.: US 2025/0313103 A1
(43) Pub. Date: Oct. 9, 2025

(54) COUPLER FOR ELECTRIC VEHICLE CHARGING

(71) Applicants: Abdelrahman Sahban ALI, TORONTO (CA); Aamir Abbas ABUBAKKAR, BRAMPTON (CA); Saksham MALIK, TORONTO (CA); Harshit MADAAN, TORONTO (CA)

(72) Inventors: Abdelrahman Sahban ALI, TORONTO (CA); Aamir Abbas ABUBAKKAR, BRAMPTON (CA); Saksham MALIK, TORONTO (CA); Harshit MADAAN, TORONTO (CA)

(21) Appl. No.: 19/169,875

(22) Filed: Apr. 3, 2025

Related U.S. Application Data
(60) Provisional application No. 63/574,957, filed on Apr. 5, 2024.

(51) Int. Cl. B60L 53/16; B60L 53/12; B60L 53/18; B60L 53/57

(52) U.S. Cl. CPC B60L 53/16; B60L 53/12; B60L 53/18; B60L 53/57

(57) ABSTRACT

A coupler for enabling a roving robot charger to charge an electric vehicle, comprising an electric nozzle adapted for electrical coupling to the charging port of the electric vehicle and an insulated flexible electrical conduit extending from the electric nozzle to an electrical interface. The electrical conduit couples the electrical nozzle in electrical communication with the electrical interface. The electrical interface is carried by a trunk securement having a first portion removably lockably securable within a trunk of the electric vehicle and a second portion supporting the electrical interface outside of the trunk. The trunk securement is configured to inhibit removal of the coupler from the electric vehicle when the trunk thereof is closed.

### CROSS-REFERENCE TO RELATED APPLICATION

This application claims the benefit of, and priority to, U.S. Provisional Patent Application No. 63/574,957 filed on Apr. 5, 2024.

### TECHNICAL FIELD

The present disclosure relates to a coupler for enabling a roving robot charger to charge an electric vehicle.

### BACKGROUND

The propulsion of electric vehicles (EVs) is powered, at least in part, by electricity in place of conventional gasoline or diesel fuel. Electric vehicles are typically charged by stationary charging “pumps” comprising an electric nozzle, similar to the fuel dispensing pumps at conventional filling stations. The user can connect the nozzle into a charging port in the side of the vehicle to recharge the electric vehicle. However, there has been an increase in the prevalence of roving robot chargers used to charge electric vehicles without, or with minimal, human interaction. These devices carry batteries atop a transport platform and navigate a parking lot with various degrees of autonomy to locate an electric vehicle and initiate a charging sequence with little or no human intervention. The robot chargers can charge an electric vehicle from their onboard batteries, and then locate a charging station to recharge those onboard batteries.

Robot chargers often require a manipulator to provide adequate reach for the robot to connect to the vehicle's charging interface, leading to connection issues and encumbering the robot during travel.

The requirement for a manipulator can be obviated by providing a coupler having one end comprising an electric nozzle that fits into the vehicle charging port and another end associated with an externally mounted electrical interface that mates with a corresponding interface on the robot. While this avoids the need for a manipulator, the coupler is easily stolen, and it is expected that the usual assortment of rogues and scoundrels would take advantage of the opportunity to do so, whether for fun or profit.

The Samsung Electric Vehicle Autonomous Recharging Robot is one example of a roving robot charger which engages with an electrical contact point on a coupler to avoid the need for a manipulator. This system attempts to resist pilfering of the coupler by affixing a portion of the coupler to the exterior of the vehicle. However, this has the potential to void a manufacturer's warranty.

### SUMMARY

According to an aspect of the present disclosure there is provided a coupler for enabling a roving robot charger to charge an electric vehicle. The coupler comprises an electric nozzle adapted for electrical coupling to the charging port of the electric vehicle, and at least one insulated flexible electrical conduit extending from the electric nozzle to an electrical interface, wherein the electrical conduit(s) couple the electrical nozzle in electrical communication with the electrical interface. The electrical interface is carried by a trunk securement having a first portion that is removably lockably securable within a trunk of the electric vehicle coupled to a second portion supporting the electrical interface outside of the trunk. The trunk securement is configured to inhibit removal of the coupler from the electric vehicle when the trunk thereof is closed.

In some embodiments, the trunk securement is adjustable to vary a height of the electrical interface, to accommodate different models of roving robot charger, which may have different height requirements for engaging with the electrical interface of the coupler. In some such embodiments, the second portion of the trunk securement comprises a suspender coupled to and supporting the electrical interface and the first portion of the trunk securement comprises a suspender lock configured to releasably lock the suspender thereto, and the suspender lock is dimensioned to be removably lockably securable within the trunk of the electric vehicle to thereby inhibit removal of the coupler from the electric vehicle when the trunk thereof is closed. In particular embodiments, the suspender lock is releasably securable to an anchor within a foldable box which has a folded configuration and an unfolded configuration. The foldable box is configured to be fastened inside the trunk at least when the foldable box is in the unfolded configuration, and the foldable box is configured to accommodate the coupler therewithin when the foldable box is in the folded configuration.

In some embodiments, the electrical interface is a contact interface. In some embodiments, the electrical interface is a wireless interface. In some embodiments, the electrical interface comprises both a wireless interface and a contact interface to accommodate different models of roving robot charger. In this way, the electric vehicle may be charged by the roving robot charger with either wired or wireless means.

In some embodiments, the first portion comprises a mechanism for affixing the first portion to an interior surface of the trunk.

In some embodiments, the first portion is shaped to obstruct withdrawal thereof from the trunk of the electric vehicle when the trunk of the electric vehicle is closed.

### BRIEF DESCRIPTION OF THE DRAWINGS

These and other features will become more apparent from the following description in which reference is made to the appended drawings wherein:

FIG. 1A depicts a roving robot charger and an electric vehicle upon which is mounted a first illustrative embodiment of a coupler according to an aspect of the present disclosure;

FIG. 1B depicts a magnified view of the coupler of FIG. 1A;

FIG. 2A depicts an electric vehicle upon which is mounted a second illustrative embodiment of a coupler in accordance with an aspect of the present disclosure;

FIG. 2B depicts the electric vehicle and coupler of FIG. 2A in electrical communication with a roving robot charger;

FIG. 3A depicts an electric vehicle upon which is mounted a third illustrative embodiment of a coupler in accordance with an aspect of the present disclosure;

FIG. 3B is a perspective view of the coupler of FIG. 3A;

FIG. 3C is a perspective view of an illustrative foldable box for use with the coupler of FIG. 3A, shown in a folded configuration;

FIG. 3D is a plan view of the foldable box of FIG. 3C, shown in an unfolded configuration;

FIG. 3E is a perspective view of the foldable box of FIG. 3C, shown in an unfolded configuration;

FIG. 3F is a perspective view of the foldable box of FIG. 3C, shown in an unfolded configuration with the coupler of FIG. 3A disposed on a bottom panel thereof;

FIG. 3G is a perspective view of the foldable box of FIG. 3C, shown in a folded configuration with the coupler of FIG. 3A contained therewithin;

FIG. 4A is a side elevation view of the electric vehicle and coupler of FIG. 3A in electrical communication with a roving robot charger;

FIG. 4B is a top perspective view of the electric vehicle and coupler of FIG. 3A in electrical communication with a roving robot charger;

FIG. 5A is a top perspective view of an electrical interface similar to that of the coupler of FIG. 3A;

FIG. 5B is a front elevation view of the electrical interface of FIG. 5A;

FIG. 6A is a top perspective view of an electrical interface similar to that of the coupler of FIG. 2A;

FIG. 6B is a front elevation view of the electrical interface of FIG. 6A;

FIG. 7A is a top perspective view of another embodiment of an electrical interface for a coupler; and

FIG. 7B is a front elevation view of the electrical interface of FIG. 7A.

### DETAILED DESCRIPTION

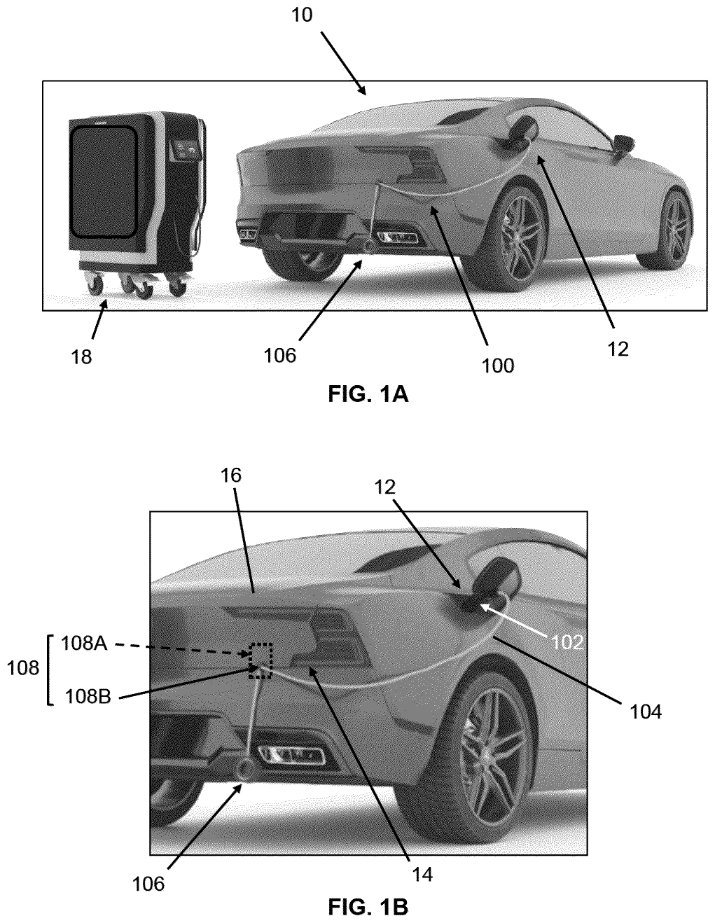

FIGS. 1A and 1B illustrate a first embodiment of a coupler 100 according to an aspect of the present disclosure, mounted upon an electric vehicle 10. The coupler 100 is configured to enable a roving robot charger 18 to charge the electric vehicle 10 by electrically coupling the robot charger 18 to the vehicle 10. Both the electric vehicle 10 and the robot charger 18 are merely illustrative, and a coupler according to the present disclosure may be used with a wide range of electric vehicles and/or robot chargers. Adaptation of a coupler according to the present disclosure to a specific electric vehicle and/or robot charger is within the capability of one of ordinary skill in the art, now informed by the present disclosure.

In FIG. 1A, the roving robot charger 18 is a wheeled robot charger that may use GPS (global positioning system) or other suitable technology to locate the electric vehicle 10 for charging. The robot charger 18 may use wired and/or wireless charging (e.g. direct electrical connection and/or induction charging) to facilitate charging of the electric vehicle 10.

The coupler 100 comprises an electric nozzle 102 (FIG. 1B) adapted for electrical coupling to a charging port 12 of the electric vehicle 10. The nozzle 102 is configured to be securely retained within the charging port 12. In this embodiment, the nozzle 102 is configured to be retained within the charging port 12 without the use of a separate retaining element; in other embodiments, a retaining element (e.g. a clip or strap) may be used.

The coupler 100 further comprises at least one insulated flexible electrical conduit 104 extending from the electric nozzle 102 to an electrical interface 106. The electrical conduit(s) 104 may comprise one or more elongate insulated flexible tubes housing at least one electrical wire, such as a braided copper wire. The electrical conduit(s) 104 couple the electrical nozzle 102 in electrical communication with the electrical interface 106. The electrical interface 106 mates with a robot charging interface on the robot charger 18, enabling current to flow from the batteries on the robot charger 18 through the robot charging interface 20, and through the electrical interface 106, the electrical conduit(s) 104 and the electric nozzle 102 to charge the electric vehicle 10. This charging may be under control of systems onboard the robot charger 18.

In preferred embodiments, the flexible tube(s) of the electrical conduit(s) 104 are brightly colored (e.g. green, orange, yellow or pink) which may be selected for contrast with the paint colour of the electric vehicle 10 to provide visual differentiation between the electrical conduit 104 and the electric vehicle 10. This may facilitate location and/or identification of the electric vehicle by the robot charger where the same is provided with an imaging system and may further serve as a guide for the robot charger to locate the electrical interface by following the path of the electrical conduit(s) 104 toward the electrical interface 106.

With reference now to FIG. 1B, the electrical interface 106 is carried by a trunk securement 108 having a first portion (locking portion) 108A removably lockably securable within a trunk 14 of the electric vehicle 10. The term “lockably” in the phrase “lockably securable within a trunk” refers to the locking of the trunk. For example, in the illustrated embodiment the first portion 108A is shaped to obstruct withdrawal thereof from the trunk 14 of the electric vehicle 10 when the trunk of the electric vehicle is closed, and is shown in dashed lines to indicate its location inside the closed trunk 14. In other embodiments, the first portion 108A may include a locking mechanism that can be locked to a secure element within the trunk, or some other mechanism (e.g. latch, carabiner, S-hook) for releasably affixing the first portion 108A to an interior element of the trunk 14 in a way that will inhibit removal of the coupler 100 from the electric vehicle 10 when the trunk 14 thereof is closed. For example, the first portion 108A may be permanently or semi-permanently affixed within the trunk 14, for example with a bolt, rivet, or other mounting hardware. The first portion 108A is configured to permit the lid 16 of the trunk 14 of the electric vehicle 10 to fully descend and thereby close the trunk 14 when the trunk securement 108 is mounted on the vehicle 10, and further configured to permit the lid 16 of the trunk 14 to lock in the descended position. In some embodiments, the trunk securement 108 may be mounted to the “frunk” of the electric vehicle 10 (i.e. when the vehicle 10 has “trunk” storage space in the front of the vehicle 10 rather than in the rear). For the avoidance of doubt, the term “trunk” as used herein refers to the main non-passenger storage compartment on the vehicle, whether at the vehicle's front or rear. Accordingly, the term “trunk” subsumes the term “frunk”.

The trunk securement 108 further comprises a second portion (carrier portion) 108B coupled to the first portion 108A and which carries the electrical conduit 104 so as to support the electrical interface 106 outside of the trunk 14. The second portion 108B of the trunk securement 108 may be adjustable to vary a height of the electrical interface 106 below a lid 16 of the trunk 14. For example, the second portion 108B may be telescopic, or otherwise adjustable. The electrical interface 106 and/or the second portion 108B may include a magnet to releasably affix the electrical interface 106 and/or the second portion 108B to the exterior of the electric vehicle 10.

The trunk securement 108 is configured to inhibit removal of the coupler 100 from the electric vehicle 10 when the trunk 14 thereof is closed. For example, in the illustrated embodiment shown in FIGS. 1A and 1B, the second portion (carrier portion) 108B of the trunk securement 108 comprises a loop through which the electrical conduit 104 passes, which loop is smaller than the electrical interface 106 and the electric nozzle 102. Thus, while the electrical conduit 104 may slide within the loop to allow for the electrical conduit to be suspended at different heights, the electrical conduit 104 and the electric nozzle 102 act as stops to prevent the electrical conduit 104 from being disengaged from the loop. When the trunk 14 of the electric vehicle 10 is closed and locked, the first portion (locking portion) 108A of the trunk securement 108 is locked in the trunk 14, inhibiting removal of the trunk securement 108 from the electric vehicle 10, and the loop of the second portion (carrier portion) 108B of the trunk securement 108 inhibits removal of the electrical conduit 104 from the trunk securement 108. This secures the coupler 100 to the electric vehicle 10.

The foregoing is merely one illustrative embodiment of a configuration in which the trunk securement 108 is configured to inhibit removal of the coupler 100 from the electric vehicle 10 when the trunk 14 thereof is closed. In another non-limiting embodiment, the second portion (carrier portion) of the trunk securement may comprise a rigid member affixed to and depending from the first portion (locking portion) of the trunk securement, with the electrical interface affixed to the second portion. In such an embodiment, when the trunk is closed, removal of the coupler from the electric vehicle is inhibited by affixation of the electrical interface to the second portion of the trunk securement, which is in turn affixed to the first portion of the trunk securement, which first portion is locked inside the trunk.

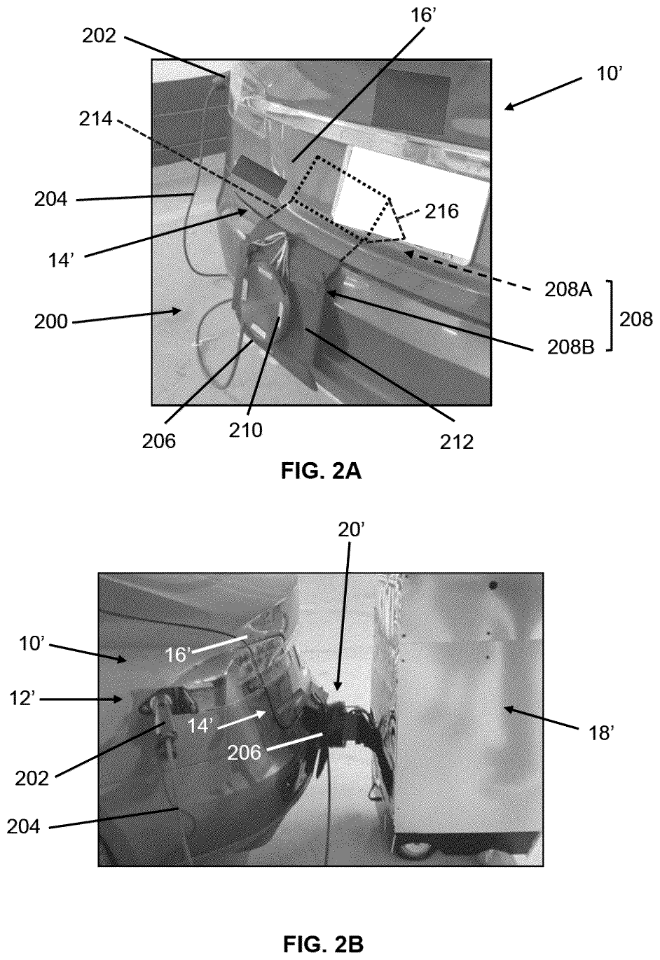

Turning to FIGS. 2A and 2B, a second embodiment of a coupler 200 according to the present disclosure is illustrated. In the following description, like reference numerals are used to represent like features which share similarities in the first and second embodiments, but with the prefix “2” rather than “1”.

The coupler 200 is mounted to an electric vehicle 10′ and is configured to enable a roving robot charger 18′ to charge the electric vehicle 10′. The coupler 200 comprises an electric nozzle 202 adapted for electrical coupling to a charging port 12′ of the electric vehicle 10′. The nozzle 202 is configured to be securely retained within the charging port 12′. The coupler 200 further comprises an insulated flexible electrical conduit 204 extending from the electric nozzle 202 to an electrical interface 206. The electrical conduit 204 couples the electrical nozzle 202 in electrical communication with the electrical interface 206. The electrical interface 206 mates with a robot charging interface 20′ on the robot charger 18′, enabling current to flow from the batteries on the robot charger 18′ through the robot charging interface 20′. The current can further flow through the electrical interface 206, the electrical conduit(s) 204 and the electric nozzle 202 to charge the electric vehicle 10′. Such charging may be under control of systems onboard the robot charger 18′.

In this embodiment, the electrical interface 206 may comprises a plurality of magnets configured to facilitate alignment and contact retention of the electrical interface 206 with a robot charging interface 20′ of the robot charger 18′. As illustrated in FIG. 2B, the electrical interface 206 of the coupler 200 is a contact interface configured to directly contact the robot charging interface 20′ of the robot charger 18′. In this way, when the electrical interface 206 and robot charging interface 20′ are aligned and in contact with one another, the interfaces are electrically coupled. Other embodiments contemplate wireless charging.

In some embodiments, at least a portion of the electrical interface 206 is shaped to complement (conform to) the shape of the robot charging interface 20′. Complementary and/or mating shapes may facilitate alignment or “mating” of the electrical interface 206 to the robot charging interface 20′, such as during docking of the robot 18′ to the coupler 200. For example, the electrical interface 206 may comprise a concave face as shown in FIG. 2A and the robot charging interface 20′ may comprise a convex face, or vice versa. In the illustrated embodiment, the electrical interface 206 comprises a plurality of contacts 210 (e.g. copper or other suitable conductor) configured to facilitate electrical coupling between the electrical interface 206 and the robot charging interface 20′ of the robot charger 18′; which would have correspondingly positioned contacts.

The electrical interface 206 is carried by a trunk securement 208 having a first portion (locking portion) 208A removably lockably securable within a trunk 14′ of the electric vehicle 10′, as illustrated in FIG. 2A. The trunk securement 208 is configured to inhibit removal of the coupler 200 from the electric vehicle 10′ when the trunk 14′ thereof is closed.

The trunk securement 208 further comprises a second portion (carrier portion) 208B which carries the electrical conduit 204 so as to support the electrical interface 206 outside of the trunk 14′. In the illustrative embodiment, the second portion 208B comprises a carrier plate 212 which carries the electrical interface 206. The carrier plate 212 is articulated to one end of a connector 214 joined at its other end to the trunk securement 208, which in the illustrated embodiment comprises a triangular prismatic member 216, although this shape is merely illustrative and not limiting. The connector 214 is configured to fit and be trapped between the body of the electric vehicle 10′ and the lid 16′ of the trunk 14′ thereof. To this end, the connector 214 may be formed from a textile or other suitable material, which may be cut resistant material. The height of the electrical interface 206 may be adjusted by changing the position at which the connector 214 is trapped between the body of the electric vehicle 10′ and the lid 16′ of the trunk 14′ thereof. Optionally, the underside of the connector 214 may be provided with the hook side of a hook-and-loop fastener arrangement (e.g. Velcro® brand) to affix the connector to carpeting inside the trunk 14′ at a desired location, or another type of affixation may be used. The dimensions (size and shape) of the triangular prismatic member 216 inhibit removal of the coupler 200 by pulling on the second portion 208B to try to forcibly free the connector 214, since the triangular prismatic member 216 is too large to fit between the body of the electric vehicle 10′ and the lid 16′of the trunk 14′ thereof.

The trunk securement 208 comprising the triangular prismatic member 216 is merely one non-limiting, illustrative embodiment and a wide range of alternate trunk securements are contemplated; these will be apparent to one of ordinary skill in the art, now informed by the present disclosure.

Other mechanisms for adjusting the height of the electrical interface are also contemplated.

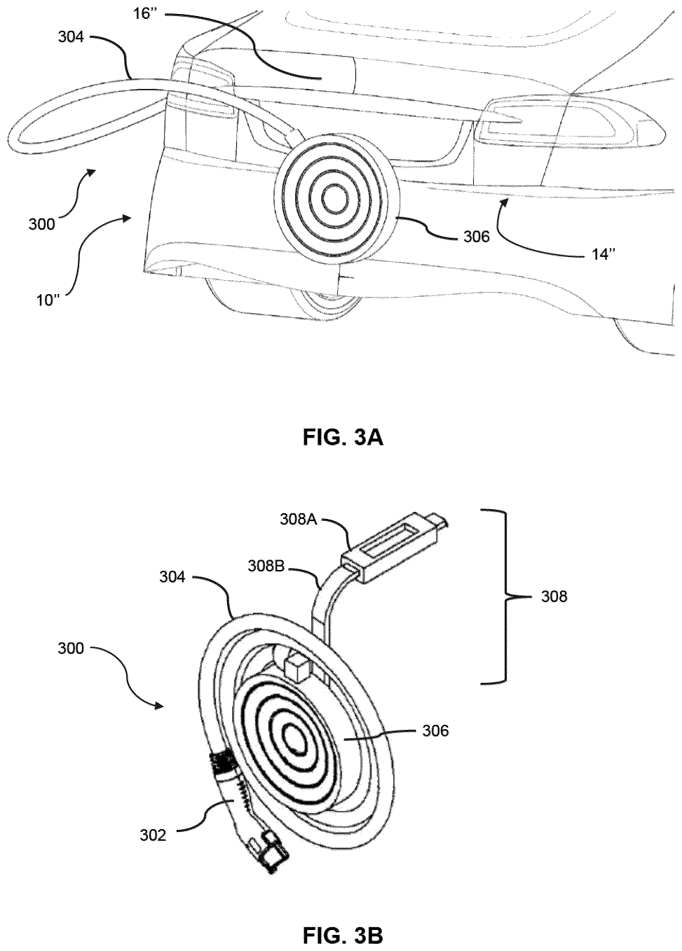

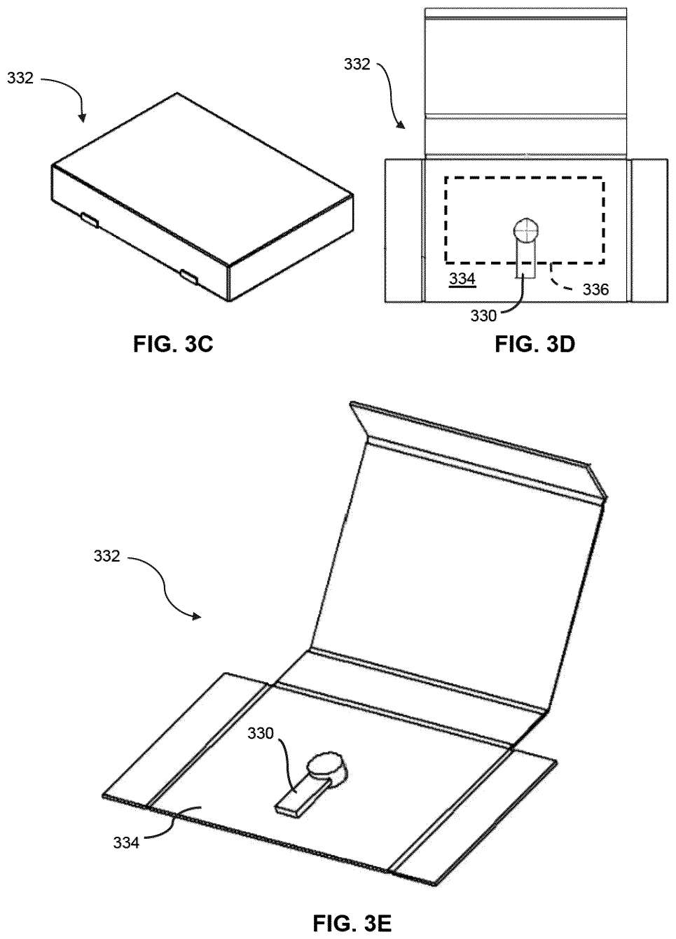

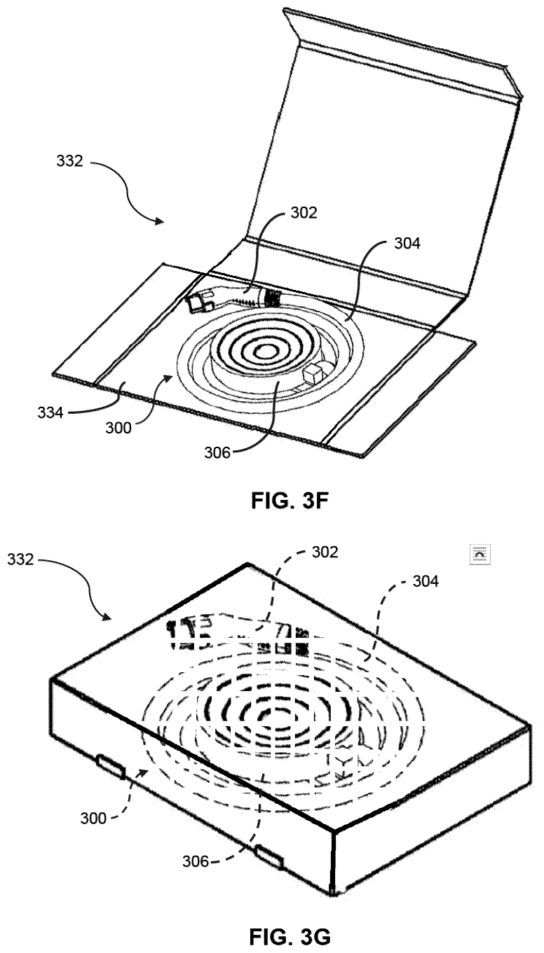

FIGS. 3A and 3B show a third embodiment of a coupler 300 according to the present disclosure. In the following description, like reference numerals are used to represent like features which share similarities with the first and second embodiments, but with the prefix “3” rather than “1” or “2”.

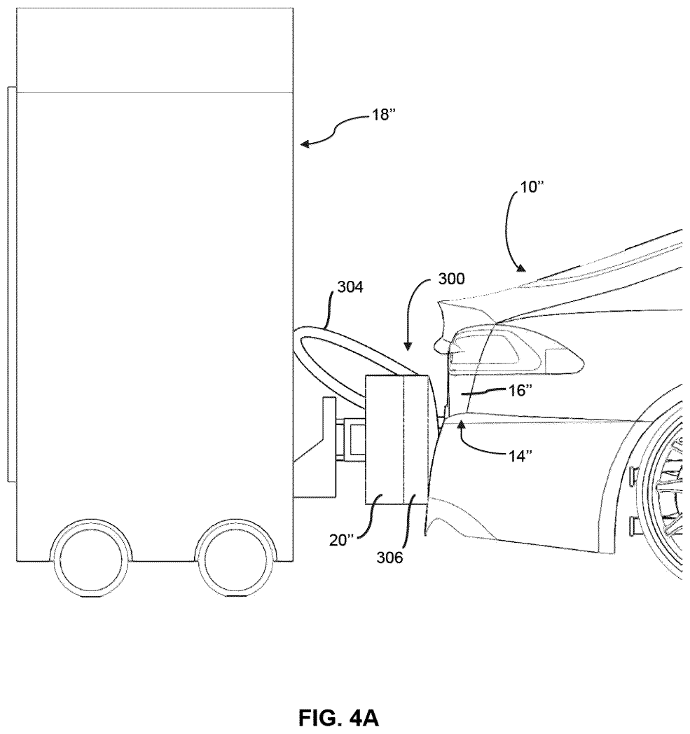

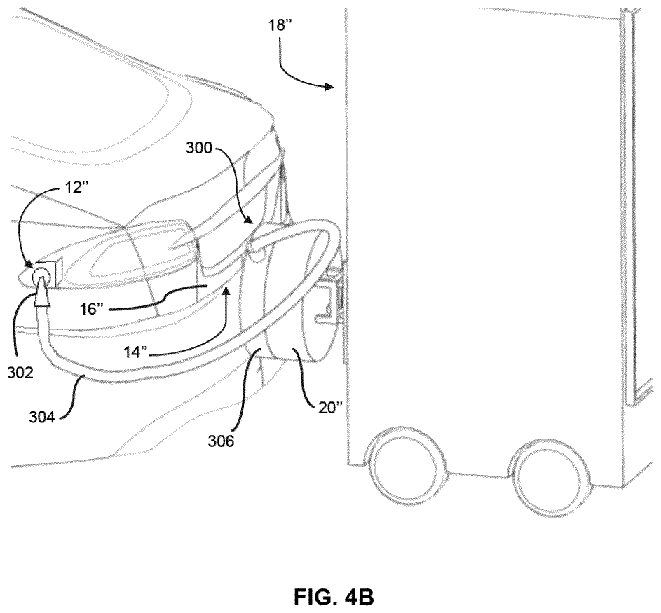

The coupler 300 is mounted to an electric vehicle 10″ and is configured to enable a roving robot charger 18″ (FIGS. 4A and 4B) to charge the electric vehicle 10″. The coupler 300 comprises an electric nozzle 302 (FIG. 3B) adapted for electrical coupling to a charging port 12″ (FIG. 4B) of the electric vehicle 10″. The nozzle 302 is configured to be securely retained within the charging port 12″ of the electric vehicle 10″ and an insulated flexible electrical conduit 304 extends from the electric nozzle 302 to an electrical interface 306 to couple the electrical nozzle 302 in electrical communication with the electrical interface 306. As shown in FIGS. 4A and 4B, the electrical interface 306 mates with a robot charging interface 20″ on a robot charger 18″. This mating enables current to flow from the batteries on the robot charger 18″ through the robot charging interface 20″, and through the electrical interface 306, the electrical conduit(s) 304 and the electric nozzle 302 to charge the electric vehicle 10″. Such charging may be under control of systems onboard the robot charger 18″.

The electrical interface 306 is carried by a trunk securement 308 (see FIG. 3B), which is adjustable to vary the height of the electrical interface 306. For the coupler 300 shown in FIGS. 3A and 3B, the first portion 308A of the trunk securement 308 comprises a suspender lock 308A, and the second portion 308B of the trunk securement 308 comprises a suspender 308B coupled to and supporting the electrical interface 306. The suspender lock 308A is configured to releasably lock the suspender 308B thereto so as to vary the length of the portion of the suspender 308B extending between the electrical interface 306 and the suspender lock 308A and thereby vary the height of the electrical interface 306 relative to the electric vehicle 10″. The suspender 308B and suspender lock 308A may be of any suitable type compatible with one another. For example, and without limitation, the suspender 308B may comprise a belt, rope or cable (preferably cut resistant) and the suspender lock 308A may comprise a corresponding releasable clamping mechanism, or a lockable spool, or the suspender 308B may be a flexible toothed rack and the suspender lock 308A may comprise a corresponding lockable pinion. Other arrangements are also contemplated.

The suspender lock 308A is shaped to obstruct withdrawal thereof from the trunk 14″ of the electric vehicle 10″ when the trunk 14″ of the electric vehicle 10″ is closed to thereby inhibit removal of the coupler 300 from the electric vehicle 10″ when the trunk 14″ thereof is closed. In the illustrated embodiment, the dimensions (size and shape) of the suspender lock 308A inhibit removal of the coupler 300 by pulling on the suspender 308A or on the electrical interface 306, since the suspender lock 308A is too large to fit between the body of the electric vehicle 10″ and the closed lid 16″ of the trunk 14″ thereof. Thus, the suspender lock 308A is removably lockably securable within the trunk 14″ of the electric vehicle 10″ while the suspender 308A supports the electrical interface 306 outside of the trunk-the trunk securement 308 is configured to inhibit removal of the coupler 300 from the electric vehicle 10″ when the trunk 14″ thereof is closed. In one embodiment, the suspender 308B is configured to fit and be trapped between the body of the electric vehicle 10″ and the lid 16″ of the trunk 14″ thereof. In such an embodiment, the suspender lock 308A may be locked to set the desired length of the relevant portion of the suspender 308B and placed just inwardly of the trunk/lid interface, and then the trunk 14″ can be closed and locked. More preferably, however, the suspender lock 308A may be provided with a mechanism (some non-limiting examples include a hook, carabiner or magnet) for maintaining the suspender lock 308A at a substantially fixed position within the trunk 14″.

Reference is now made to FIGS. 3C to 3G, which show aspects of a preferred embodiment of a mechanism for maintaining the suspender lock 308A at a substantially fixed position within the trunk 14″. In this preferred embodiment, the suspender lock 308A is releasably securable to an anchor 330 affixed to a foldable box 332 which has a folded configuration (FIG. 3C) and an unfolded configuration (FIG. 3D). The foldable box may be releasably maintained in the folded configuration by one or more releasable fasteners, or by magnets, for example. A buckle, latch, magnet or any other suitable releasable securing mechanism may be used to releasably secure the suspender lock 308A to the anchor 330. The foldable box 332 is configured to be fastened inside the trunk 14″ at least when the foldable box 332 is in the unfolded configuration. For example, the outer surface of the bottom panel 334 of the foldable box 332 (i.e. the underside thereof) may be provided with a patch 336 of the hook side of a hook-and-loop fastener arrangement (e.g. Velcro® brand) to affix the foldable box 332 to carpeting inside the trunk 14″ at a desired location, or another type of fastening may be used. Alternatively, the foldable box 332 may be weighted to balance the weight of the electrical interface 306. With either arrangement, the foldable box 332 may be placed at a desired position within the trunk 14″ which in turn maintains the suspender lock 308A at a substantially fixed position within the trunk 14″.

As can be seen in FIGS. 3F and 3G, the foldable box 332 is configured to accommodate the coupler 300 therewithin when the foldable box 332 is in the folded configuration. For example, the suspender lock 308A may be disconnected from the anchor 330 on the lower panel 334 and then the electrical conduit 302 may be coiled around the electrical interface 306 and the coupler 300 can then be placed on the bottom panel 334, as shown in FIG. 3F. The foldable box 332 can then be folded into the folded configuration around the coupler 300 to contain the coupler 300 within the foldable box, as shown in FIG. 3G. Although in the illustrated embodiment the suspender lock 308A is releasably securable to the anchor 330, in other embodiments the suspender lock may be permanently secured to the anchor, which may pivot relative to the foldable box.

FIGS. 4A and 4B show a robot charging interface 20″ of a robot charger 18″ engaged with the electrical interface 306 of the coupler 300. In the embodiment shown in FIGS. 3A to 4B, the electrical interface 306 of the coupler 300 is a contact interface configured to directly contact the robot charging interface 20″ of the robot charger 18″ and thereby electrically couple the two interfaces, although wireless charging is also within contemplation.

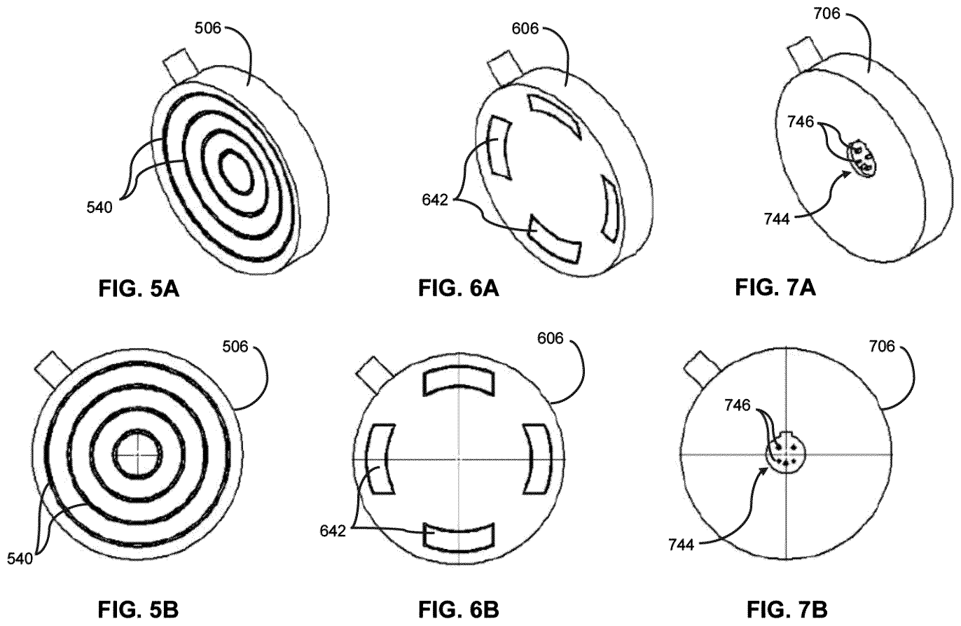

The electrical interfaces 106, 206, 306 shown herein are merely illustrative and not limiting. Couplers according to aspects of the present disclosure may have a wide range of different electrical interfaces, depending upon the particular robot charger with which they are to be used. FIGS. 5A to 7B show certain non-limiting embodiments of contact arrangements for electrical interfaces for couplers according to aspects of the present disclosure.

FIGS. 5A and 5B show an illustrative concave electrical interface 506 similar to that shown in FIGS. 3A and 3B, in which a series of concentric conductive rings 540 are used to make electrical contact with a corresponding convex robot charging interface.

FIGS. 6A and 6B show an illustrative concave electrical interface 606 similar to that shown in FIGS. 2A and 2B, in which a plurality of circumferentially spaced conductive contacts 642 are used to make electrical contact with a corresponding convex robot charging interface.

FIGS. 7A and 7B show an illustrative concave electrical interface 706 having a central recess 744 in which a plurality of conductive male pins 746 are disposed. The male pins can be received within corresponding female socket in a central protrusion on a corresponding convex robot charging interface to achieve electrical contact therewith.

The electrical interface or the robot charging interface may be provided with an insulated shroud so that the electrical interface fits within the shroud on the robot charging interface, or the robot charging interface fits within the shroud on the electrical interface, to shield the electrical contacts when the electrical interface and the robot charging interface are engaged during charging.

One or more features of any one or more embodiments described herein may be combined with one or more features of one or more other embodiments described herein.

The foregoing descriptions of configurations for a trunk securement configured to inhibit removal of the coupler from the electric vehicle when the trunk thereof is closed are merely illustrative, non-limiting embodiments and other embodiments are also contemplated. For example, and without limitation, a first portion of a trunk securement may be secured to a lid of a trunk, or a box similar to that shown in FIGS. 3C to 3G may be embedded within a floor of the trunk.

A trunk securement may be of monolithic construction or multi-part construction, depending upon the particular embodiment.

The coupler 100, 200, 300 may comprise one or more temperature, humidity or wear-and-tear sensors, or combinations thereof.

The coupler 100, 200, 300 may comprise one or more sensors configured to detect incomplete and/or complete retention of the electric nozzle 102, 202, 302 within the charging port 12, 12′, 12″ of the electric vehicle 10, 10′, 10″.

The coupler 100, 200, 300 may comprise one or more sensors configured to detect incomplete and/or complete mating of the electrical interface 106, 206, 306 to the roving robot charger 18, 18′, 18″.

Any of these sensors may be coupled to an indicator, such as a display screen, or one or more LEDs, or an audible alarm, or may be coupled with a wireless module to communicate with another wireless device, for example the robot charger or a smartphone, by way of suitable data connection (e.g. cellular data, LTE, 5G, Bluetooth, etc.).

Certain illustrative embodiments have been described by way of example. It will be apparent to persons skilled in the art that a number of variations and modifications can be made without departing from the scope of the disclosure as defined in the claims.

What is claimed is:

1. A coupler for enabling a roving robot charger to charge an electric vehicle, the coupler comprising:
an electric nozzle adapted for electrical coupling to the charging port of the electric vehicle; and
at least one insulated flexible electrical conduit extending from the electric nozzle to an electrical interface, wherein the at least one electrical conduit couples the electrical nozzle in electrical communication with the electrical interface;
characterized in that:
the electrical interface is carried by a trunk securement having a first portion removably lockably securable within a trunk of the electric vehicle and a second portion supporting the electrical interface outside of the trunk, wherein the trunk securement is configured to inhibit removal of the coupler from the electric vehicle when the trunk thereof is closed.

2. The coupler of claim 1, wherein the trunk securement is adjustable to vary a height of the electrical interface.

3. The coupler of claim 1, wherein the electrical interface is a contact interface.

4. The coupler of claim 1, wherein the electrical interface is a wireless interface.

5. The coupler of claim 1, wherein the first portion comprises a mechanism for affixing the first portion to an interior surface of the trunk.

6. The coupler of claim 1, wherein the first portion is dimensioned to obstruct withdrawal thereof from the trunk of the electric vehicle when the trunk of the electric vehicle is closed.

7. The coupler of claim 2, wherein:
the second portion of the trunk securement comprises a suspender coupled to and supporting the electrical interface; and
the first portion of the trunk securement comprises a suspender lock configured to releasably lock the suspender thereto;
wherein the suspender lock is shaped to obstruct withdrawal thereof from the trunk of the electric vehicle when the trunk of the electric vehicle is closed to thereby inhibit removal of the coupler from the electric vehicle when the trunk thereof is closed.

8. The coupler of claim 7, wherein:
the suspender lock is releasably securable to an anchor affixed to a foldable box which has a folded configuration and an unfolded configuration;
the foldable box is configured to be fastened inside the trunk at least when the foldable box is in the unfolded configuration; and
the foldable box is configured to accommodate the coupler therewithin when the foldable box is in the folded configuration.
